(19) United States
(12) Patent Application Publication
(10) Pub. No.: US 2008/0045330 A1
(43) Pub. Date: Feb. 21, 2008

(54) PLAYER REWARD SYSTEM

(76) Inventor: Chi We Chim, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 11/828,779

(22) Filed: Jul. 26, 2007

(30) Foreign Application Priority Data
Jul. 28, 2006 (AU) 2006904108

(51) Int. Cl. G06F 19/00; A63F 9/24

(52) U.S. Cl. 463/25

(57) ABSTRACT

The invention relates to a method of operating a gaming system or network comprising a plurality of linked gaming machines. The method involves monitoring an aspect of player activity of an identified player on one or more of the gaming machines and, dependent on the monitored activity of the player, an award is provided to another player. Preferably the award is only awarded to the other player after the other player has identified themselves at a location in the gaming system or network. The award may take the form of a player favourable modification of the gaming machine on which the other player is playing. Such a modification may be, for example, making the other player eligible for an award such as a jackpot or special bonus.

### CROSS REFERENCE TO RELATED APPLICATIONS

This application claims priority to Australian Patent Application No. AU2006904108, having an international filing date of Jul. 28, 2006, entitled “Player Reward System”, which is hereby incorporated by reference herein in its entirety.

### FIELD OF THE INVENTION

The present invention relates to gaming apparatuses and methods of gaming. In particular, the present invention relates to gaming apparatuses and methods for use in player monitoring systems of gaming networks.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues. In response to this need, suppliers of gaming devices and systems have attempted to provide the sought after variety, while still developing games that comply with the relevant regulations in the jurisdiction of the gaming venue operator.

However, few gaming venues have exclusive rights to any one gaming machine of a gaming machine supplier and this therefore reduces the ability of a gaming venue to distinguish itself. Also, customers may readily change between gaming venues.

Some gaming venues have established loyalty schemes to encourage return patronage. These may operate by the player inserting a machine readable card into a card reader at a gaming machine. The card reader extracts a player identification from the card and allowing the player's game activity to be tracked and associated with identification details for the player. The gaming venue can then offer goods, services or monetary reward depending on play at the gaming venue.

Uptake of loyalty schemes by players may be limited by a number of factors, including the time required to sign up for the loyalty scheme, the preference of some players to remain anonymous to the gaming venue and not wishing to have their gaming activity tracked, the requirement to carry a machine readable card, or for other reasons.

Any reference in this specification to the prior art does not constitute an admission that such prior art was well known or forms part of the common general knowledge in any jurisdiction.

### SUMMARY OF THE INVENTION

According to a first aspect, the invention broadly resides in a method of operating a gaming system or network comprising at least one gaming machine, the method comprising:

monitoring an aspect of player activity of an identified player on the gaming machines; and

dependent on the monitored player activity of the player, providing an award to another player.

According to a second aspect, the invention broadly resides in a gaming system or network comprising at least one gaming machine, the gaming system or network operable to:

monitor an aspect of player activity of an identified player on the gaming machine(s); and

dependent on the monitored player activity of the player, provide an award to another player.

According to a third aspect, the invention broadly resides in a gaming system or network comprising at least one gaming machine, the gaming system or network comprising an electronic processing system operable to:

maintain a record of identifiers for a plurality of players and associate the identifiers of two or more of those players with the identifier of another player;

monitor an aspect of player activity of the plurality of players on the gaming machine(s); and

dependent on the monitored player activity of the plurality of players, provide an award to the other player.

In certain embodiments, the award is only awarded to the other player after the other player has identified themselves at a location in the gaming system or network. The location may be one of the gaming machines.

In certain embodiments, the award is able to be redeemed by the other player only by playing a game on one of the gaming machines.

In one embodiment, the award is an award of credits able to be wagered on game play on a gaming machine in the system or network, or a value able to be exchanged for such credits.

In another embodiment, the award is a modification of the play characteristics of the gaming machine. The modified play characteristics preferably cause an increase in the expected return to player for the other player. The additional features may be one of a modified pay table, modified playing elements so as to result in an increased frequency of winning outcomes, the provision of a feature game or the ability to win a feature game.

In certain embodiments, the magnitude of the award is dependent on the magnitude of the monitored player activity and/or the timing of the award is dependent on the magnitude of the monitored player activity.

In certain embodiments, players of the gaming system or network may identify themselves by inserting a machine readable card into a card reader. The card reader may be operable to both read data from and write data to the machine readable card. The gaming system or network may be operable to provide the award to the other player by writing data indicative of the reward to the machine readable card of the other player.

According to a fourth aspect, the invention broadly resides in a gaming system or network comprising a plurality of gaming machines, the gaming system or network comprising:

computer readable memory storing a player identifier of a player and associated with that player identifier a player identifier of another player;

an interface at each gaming machine to enable the player and the other player to identify themselves at any one of the gaming machines by using the interface to input a player identifier;

at least one computational controller that receives player identifiers from the interfaces of the gaming machines and:

a) identifies when a received player identifier is the player identifier of the player and monitors an aspect of player activity of the player on the gaming machines; and

b) identifies when a received player identifier is the player identifier of the other player, and dependent on the monitored player activity of the player causes the gaming machine associated with the interface from which the player identifier of the other player was received to provide an award to the other player.

In certain embodiments, the award is one or more modified play characteristics of a game playable on the gaming machines.

The monitored player activity may comprise accumulated player activity over a plurality of gaming sessions and may comprise player activity at a plurality of gaming machines.

The gaming system or network may consist of a local area network at a single gaming location, a network spanning two or more gaming locations and/or may consist in part of a wide area network.

Further aspects of the present invention will become apparent from the following description, given by way of example only and with reference to the accompanying drawings.

### BRIEF DESCRIPTION OF THE DRAWINGS

Notwithstanding any other embodiments that may fall within the scope of the present invention, certain embodiments of the present invention will now be described, by way of example only, with reference to the accompanying figures, in which:

FIG. 1: shows a block diagram of gaming apparatus suitable for implementing certain embodiments of the present invention.

FIG. 2: shows a block diagram of components of the memory of the gaming apparatus represented in FIG. 2.

FIG. 3: shows diagrammatically, a network gaming system suitable for implementing certain embodiments of the present invention.

FIGS. 4A and 4B: show a flow diagram of a process able to be implemented by the gaming system of FIG. 3 and according to an embodiment of the present invention.

### DETAILED DESCRIPTION

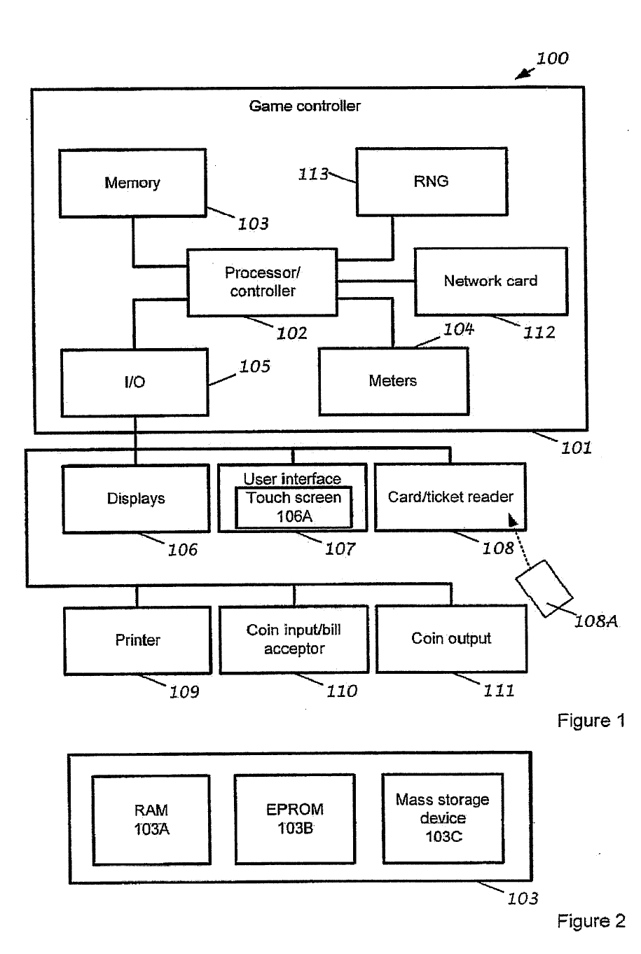

FIG. 1 shows a block diagram of a gaming apparatus, generally referenced by arrow 100, suitable for implementing certain embodiments of the present invention. The gaming apparatus 100 operates as a networked gaming machine, communicating with other network devices, such as one or more servers or other gaming machines. The gaming apparatus 100 may be contained in a single unit or have distributed hardware and software components that communicate with each other directly or through a network or other communication channel.

The gaming apparatus 100 includes a game controller 101, which in the illustrated example includes a microprocessor, microcontroller, programmable logic device or other computational device 102. Instructions and data to control operation of the computational device 102 are stored in a memory 103, which is in data communication with the computational device 102. Typically, the gaming apparatus 100 will include both volatile and non-volatile memory and more than one of each type of memory, with such memories being collectively represented by the memory 103. The instructions to cause the game controller 101 to implement the present invention will be stored in the memory 103.

The gaming apparatus may include hardware meters 104 for the purposes of regulatory compliance and also include an input/output (I/O) interface 105 for communicating with the peripheral devices of the gaming apparatus 100. The input/output interface 105 and/or the peripheral devices may be intelligent devices with their own memory for instructions and data.

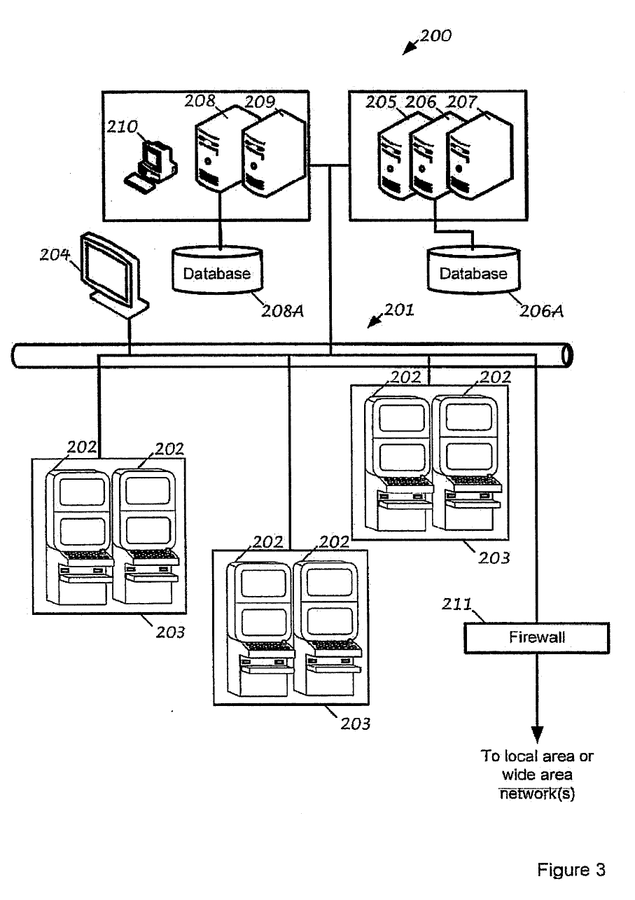

In the example shown in FIG. 2, the peripheral devices that communicate with the controller are one or more displays 106, user interfaces 107, a card and/or ticket reader 108, a printer 109, a bill acceptor and/or coin input mechanism 110 and a coin output mechanism 111. One or more of the displays 106 may include a touch screen 106A, forming part of the user interface 107. The card reader 108 may read a machine readable card 108A. The machine readable card 108A may contain a player identifier for the holder of the card, which can be read by the card reader 108 and forwarded to one or both of the game controller 101 and another device in a network to which the gaming apparatus 100 is connected. Additional devices may be included as part of the gaming apparatus 100, or devices omitted as required for the specific implementation.

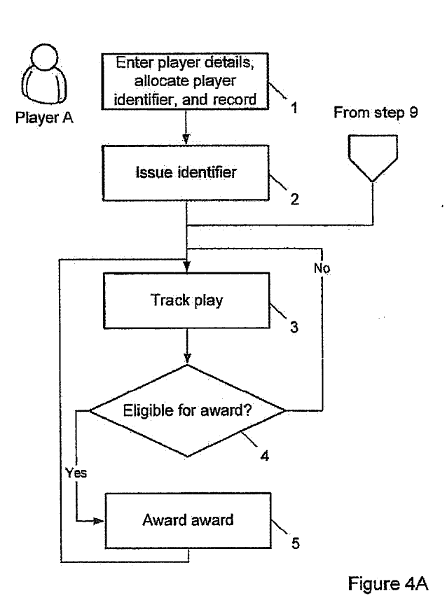

In addition, the gaming apparatus 100 includes a communications interface, for example a dedicated machine communications interface or a network card 112. The network card 112, may for example, send status information, accounting information or other information to a central controller, server or database and receive data or commands from a the central controller, server or database. The game controller 101 may also include a random number generator 113, which generates a series of random numbers that determine the outcome of a series of random game events played as part of a game on the gaming apparatus 100. As explained in more detail in relation to FIG. 3, the computational device 102 may include two or more controllers or processors, which may be local or remote from each other and the displays 106.

FIG. 2 shows an exemplary block diagram of the main components of the memory 103. The RAM 103A typically temporarily holds program files for execution by the computational controller 102 and related data. The EPROM 103B may be a boot ROM device and/or may contain some system or game related code. The mass storage device 103C is typically used to store game programs, the integrity of which may be verified and/or authenticated by the computational controller 102 using protected code from the EPROM 103B or elsewhere.

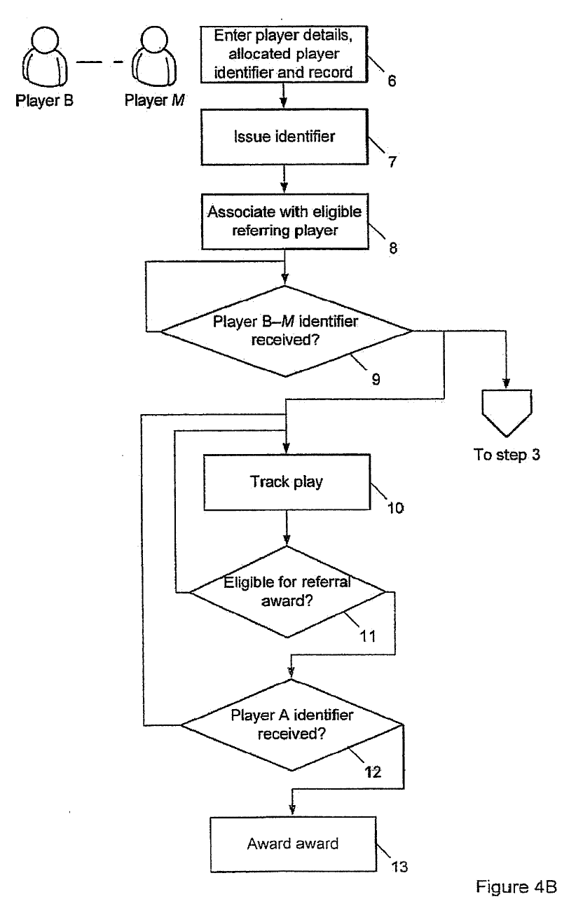

FIG. 3 shows a gaming network 200. The gaming network 200 includes a network infrastructure 201, which for example may be an Ethernet. Gaming devices 202, shown arranged in three banks 203 of two gaming devices 202 in FIG. 4, are connected to the network infrastructure 201. The gaming devices 202 may form part or all of a gaming apparatus 100. Single gaming devices 202 and banks 203 containing three or more gaming devices 202 may also be connected to the network infrastructure 201.

One or more displays 204 may also be connected to the network infrastructure 201. The displays 204 may, for example, be associated with a bank 203 of gaming devices. The displays 204 may be used to display representations associated with game play on the gaming devices 202, and/or used to display other representations, for example promotional or informational material.

Servers may also be connected to the network infrastructure 201. For example, a game server 205 may generate game outcomes for games played on the gaming devices 202, a database management server 206 may manage the storage of game programs and associated data for downloading or access by the gaming devices 202 in a database 206A, and a jackpot server 207 may control one or more jackpots associated with the gaming devices 202.

Further servers may be provided to assist in the administration of the gaming network 200, including for example a gaming floor management server 208, and a licensing server 209 to monitor the use of licenses to particular games. A database 208A may be managed by the floor management server 208 to contain data associated with the operation of the gaming network 200, including for example accounting information, player identity information and player account information. An administrator terminal 210 is provided to allow an administrator to run the gaming network 200.

The gaming network 200 shown in FIG. 4 may communicate with other gaming systems, other local networks, for example a corporate network and/or a wide area network such as the Internet through a firewall 211 and may thereby form a larger gaming network 200.

FIGS. 4A and 4B together show a flow diagram of a process according to certain embodiments of the present invention. The process may be implemented by the gaming network 200 where each gaming device 202 is a gaming apparatus 100. The following exemplary description is given with reference to a method of operating such a gaming network 200 in accordance with one embodiment of the present invention. Those skilled in the relevant arts will appreciate that certain embodiments of the present invention may be implemented in alternative ways in the gaming network 200 and in alternate gaming networks. Certain embodiments of the present invention may also be implemented in a gaming system formed by a single gaming apparatus 100, which maintains its own records, or in a gaming system formed by a plurality of standalone gaming apparatuses 100, with operators of the gaming system physically transferring data carriers between gaming apparatuses 100.

Referring to FIG. 4A, a player (Player A) of the gaming devices 202 joins a loyalty programme offered by the gaming venue operator. Player A may provide details required by the gaming venue operator, although the player need not provide their name or any other any personal details. However, if personal details are provided, the gaming venue operator may use these to provide a more personalised service to the player. The details are entered by the gaming venue operator, for example using the administrator terminal 210 or another terminal connected to the gaming network 200 and these are communicated to the floor management server 208 for storage in the database 208A (step 1).

The gaming venue operator then issues an identifier (step 2). The identifier is preferably data stored in a machine readable card 108A (see FIG. 1), for example a magnetic stripe card or a smart card, but alternatives may be used, including giving the player a code for entry at an interface device, for example a suitable peripheral of a gaming device 202, using biometric information, or otherwise. Combinations of identifiers may be used, for example a combination of a code on a card together with a user name and password entered at a user interface. The following description assumes that the identifier is entirely contained within a machine readable card 108A in the form of a smart card.

After Player A is issued with the smart card, she may insert the smart card into a card reader 108. The card reader reads the player identifier from the card and communicates this onto the network infrastructure 201 via the computational controller 101 and the network card 112. Alternatively, the card reader 108 may be able to bypass the computational controller 101 and communicate directly with the network card 112.

The floor management server 208 identifies the data placed on the network infrastructure 201, reads the data and evaluates whether there is a matching entry in its database 208A. If there is not a match, an error occurs and predefined steps are taken in response. If there is a match, then the activities of Player A are monitored (step 3). These activities may include the total turnover on the gaming device 202 that occurs while Player A has her smart card inserted into the card reader of the gaming device 202, the total wins or losses resulting from play, the rate of play and/or other information.

The monitoring of player activity may be achieved by the floor management server 208 communicating a current balance of a player account associated with the identifier of Player A in the database 208A to the gaming device 202 where Player A inserted her smart card. The gaming device 202 may then monitor the player activity and send an updated account balance to the floor management server 208A when the gaming session ends, which is typically signified by Player A removing her smart card from the card reader 108 of the gaming device 202. The following description assumes this implementation. In alternative implementations the gaming device 202 may send information indicative of the player activity of Player A to the floor management server 208, which then updates the player account. This may be performed following each event that causes a change in the account balance or as a batch operation.

The loyalty scheme may operate based on the accumulation of player points. The points may accumulate at a defined rate relative to the rate of player activity. For example, for every 100 credits turnover on a gaming machine, the player may be allocated 10 points. The points may then be converted into redeemable awards, for example credits for play on the gaming devices 202, food vouchers, services or other awards.

The gaming device 202 evaluates whether Player A is eligible for an award (step 4). This step may be performed in a similar manner to existing loyalty systems, for example monitoring for minimum threshold of player points accumulated as a result of player activity, following which an award is awarded, which may be, for example a number of credits. If Player A is eligible for an award, then an award is awarded (step 5), either automatically or at the request of Player A.

Referring now to FIG. 4B, another player (Player B) joins the loyalty programme. Like Player A, Player B provides such details as may be required by the gaming venue operator and these are entered into the database 208A associated with a player identifier for Player B (step 6). Player B is then issued with a player identifier (step 7).

During the joining process or subsequent to the joining process, it is identified that Player B was referred to the loyalty programme by Player A. In response, the gaming venue operator associates the identifier of Player B with the identifier of Player A in the database 208A (step 8) or otherwise associates Player B with Player A. The joining process may be repeated for other players (Players C to M) referred to the loyalty programme by Player A, each of which are allocated a player identifier that is associated with the player identifier of Player A.

When it is detected that the player identifier of one of the Players B-M that are associated with the player identifier of Player A has been provided at a gaming console 202 (step 9), the player activity of that player is monitored (step 10). One or more variables indicative of player activity on the gaming network 200 may be monitored. A currently contemplated preferred variable is turnover on the gaming device 202 that occurs while the player has inserted their card.

The player activity from a current gaming session by a Player B-M may be added to historical player activity. The historical gaming activity may be the activity for that player only so as to reward referring players for referring other players that meet certain criteria. Alternatively or in addition the historical gaming activity may be the summation of the activity of all players B-M, so as to reward referring players for referring business, regardless of how across how many number of players the business is spread. If both measures are used, the award may be the same or different once the eligibility criteria have been met and the eligibility criteria may be different. For example, if player activity for all referred players is used, the threshold for eligibility may be high and the award may be high. If player activity for a single player is used the threshold for eligibility may be lower and the award also lower in value.

It is not essential for there to be a specific threshold for eligibility of an award and the player may automatically receive an award for referring another player that joins the loyalty scheme. Alternatively or in addition, subject to a minimum denomination of award size, such as one credit, an award may be available for any level of player activity by referred players, the size of the award increasing with the player activity of referred players.

When it is determined that the player is eligible for an award (step 11), the gaming network 200 may either automatically award the award, or may award eligibility for the award (step 13). An automatic award may be crediting a player account stored in the database 208A with an amount of credits.

An award that is not automatically paid, but which the player becomes eligible for may be an award that modifies game characteristics of a game played at a gaming device by Player A (as determined by receipt of their identifier (step 12)). This may be achieved by:

a) modifying the pay table to pay larger prizes;

b) modifying game play to result in an increased chance of a win;

c) modifying game play so that prizes are paid for outcomes that previously did not pay a prize;

d) making a feature game with a high expected return to player available;

e) awarding a number of free games (i.e. game plays on a gaming console that would normally require a wager); and

f) awarding credits that refund part or all of wagers made on a gaming device 202.

The awards a) to f) may be provided alone or in combination. For example, a number of free games with modified play characteristics may be provided as an award. These types of awards are not automatically awarded, because they are dependent on game play by Player A. Those skilled in the relevant arts will appreciate that other awards may be provided.

The awards a) to f) and other awards are expected to be more easily provided with a threshold for eligibility. Multiple thresholds may be provided each subsequent threshold being associated with a correspondingly larger award. The threshold that is applicable will depend on how much player activity occurred by referred players during the time that Player A did not provide her player identifier. Any “remainder” amount that is insufficient to reach the next threshold, but exceeds the threshold required for the currently awarded award may be retained and added to subsequent player activity records of referred players.

Where the players use smart cards as identifiers, the award may be communicated to and stored in the smart card. For example a balance of credits may be stored in the smart card that can be transferred to a credit meter of a gaming device 202 or may be able to be redeemed at a cashier's station. Where the award is modified play characteristics of a game played by a gaming device, the smart card may store information indicating that the player has been awarded this award and the level of the award if multiple levels of modification are available. The smart card may also store other data particularising the award, for example a count of the number of games that can be played with modified play characteristics. The gaming device 202 reads the smart card when it is inserted, makes the modifications either automatically or on command by the player (the player may indicate their wish to use their using the user interface to the gaming device 202), and informs the smart card of consumption of the award by either sending a particular command or data to the smart card, which is acted on by the smart card to delete or reduce the award, or by more directly updating the memory of the smart card.

Where the award is game play related, qualifications may be placed on the consumption of the award. One qualification that has already been described is that the award is modified play characteristics for a limited number of game plays. However, other qualifications could end the award, for example a certain minimum amount of winnings, a certain amount of turnover or a particular game event. Where a minimum amount of winnings is used, this has the advantage of helping to ensure that the player is satisfied with the result of the award, particularly when the modified play characteristics may not necessarily always result in an increased payout to the player or could result in the consumption of the award without any return.

If the award is food or drink vouchers or other goods or services that are not consumable using a gaming device 202, then the player may present their smart card at a service point, for reading by a smart card reader and redemption.

In addition to the player activity of Players B-M leading to benefit or potential benefit to Player A, Players B-M receive benefit from their own game play. Therefore, following step 9 steps 3 to 5 are completed at the same time as steps 10 to 13. The player activity monitored in steps 3 and 10 may be the same or different and each may relate to a single variable, for example turnover, or may relate to a combination of variables, which may be weighted or otherwise mathematically combined. For example, the player activity may be dependent on both the wins of the referred players and their turnover.

While the foregoing description focussed on the referral of players, other relationships could lead to the association of players. For example, a player that joins a loyalty programme may be invited to list a group of friends or colleagues and may become entitled to a reward based on player activity by any of the friends or colleagues should they identify themselves to the gaming network 200, regardless of whether or not there was an actual referral. Equally, if an existing loyalty scheme member is included on a list of friends or colleagues of a new member, then the existing member may receive benefit from player activity of the new player. In a further extension, both players may receive benefit from the player activity of each other.

In a still further embodiment, Player A may receive some benefit from the player activity of any players referred to the loyalty scheme by one of Players B-M. This preferably does not affect the benefit provided to the Player B-M who made the referral, but is awarded by the gaming venue operator in addition to the benefit to the Player B-M. The benefit from these indirect referrals may be smaller than the benefit obtained for direct referrals. Player A may receive benefit from further referrals from the players that were referred by the Players B-M and so on. However, there is preferably a limit on the number of stages and it is anticipated that this limit will be best at one or two stages.

While the foregoing description has been provided by way of example of certain embodiments of the present invention as presently contemplated, which utilise gaming apparatus and machines, those skilled in the relevant arts will appreciate that certain embodiments of the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of operating a gaming system or network comprising a plurality of gaming machines, the method comprising:
monitoring an aspect of player activity of an identified player on the gaming machines; and
dependent on the monitored player activity of the player, providing an award to another player.

2. A method according to claim 1 wherein the award is only awarded to the other player after the other player has identified themselves at a location in the gaming system or network.

3. A method according to claim 2 wherein the location is one of the gaming machines of the system or network.

4. A method according to claim 1 wherein the award is able to be redeemed by the other player only by playing a game on one of the gaming machines.

5. A method according to claim 4 wherein the award is an award of credits able to be wagered on game play on a gaming machine in the system or network, or a value able to be exchanged for such credits.

6. A method according to claim 4 wherein the award is a modification of the play characteristics of the gaming machine on which said other player is playing.

7. A method according to claim 6 wherein the modified play characteristics cause an increase in the expected return to player for the other player.

8. A method according to claim 7 wherein the modified play characteristics is one of a modified pay table, modified playing elements so as to result in an increased frequency of winning outcomes, the provision of a feature game, or enhanced eligibility to win a feature game.

9. A method according to claim 1 wherein the magnitude of the award to the other player is related to the magnitude of the monitored player activity and/or the timing of the award is dependent on the magnitude of the monitored player activity.

10. A method according to claim 1 wherein the players of the gaming machines identify themselves by inserting a machine readable card into a card reader.

11. A gaming system or network comprising a plurality of gaming machines, the gaming system or network operable to:
monitor an aspect of player activity of an identified player on a gaming machine of the system or network; and
dependent on the monitored player activity of the player, provide an award to another player.

12. A gaming system or network comprising a plurality of gaming machines, the gaming system or network comprising an electronic processing system operable to:
maintain a record of identifiers for a plurality of players and associate the identifiers of two or more of those players with the identifier of another player;
monitor an aspect of player activity of the plurality of players on the gaming machines; and
dependent on the monitored player activity of the plurality of players, provide an award to the other player.

13. A gaming system or network comprising a plurality of gaming machines, the gaming system or network comprising:
computer readable memory storing a player identifier of a player and associated with that player identifier a player identifier of another player;
an interface at each gaming machine to enable the player and the other player to identify themselves at any one of the gaming machines by using the interface to input a player identifier;
at least one computational controller that receives player identifiers from the interfaces of the gaming machines and:
a) identifies when a received player identifier is the player identifier of the player and monitors an aspect of player activity of the player on the gaming machines; and
b) identifies when a received player identifier is the player identifier of the other player, and dependent on the monitored player activity of the player causes the gaming machine associated with the interface from which the player identifier of the other player was received to provide an award to the other player.

14. A gaming system or network according to claim 11 wherein the award to the other player is awarded by modifying the play characteristics of a game played by the other player on a gaming machine in a player favourable manner.

15. A gaming system or network according to claim 14 wherein the modification comprises any one or more of a modified pay table, modified playing elements so as to result in an increased frequency of winning outcomes, the provision of a feature game, or enhanced eligibility to win a feature game.

16. A gaming system of network according to claim 15 wherein each gaming machine in the system or network includes a player identity reader able to identify and distinguish between different players playing the machine.

17. A gaming system or network according to claim 16 wherein the player identity reader is operable to both read data from and write data to a machine readable card associated with the player.

18. A gaming system or network according to claim 17 wherein the player identity reader is operable to provide the award to the other player by writing data indicative of the reward to the machine readable card of the other player.

19. A gaming system or network according to claim 18 comprising a local area network at a single gaming location, a network spanning two or more gaming locations and/or part of a wide area network.

20. A gaming system or network according to claim 12 wherein the award to the other player is awarded by modifying the play characteristics of a game played by the other player on a gaming machine in a player favourable manner.

21. A gaming system or network according to claim 20 wherein the modification comprises any one or more of a modified pay table, modified playing elements so as to result in an increased frequency of winning outcomes, the provision of a feature game, or enhanced eligibility to win a feature game.

22. A gaming system of network according to claim 21 wherein each gaming machine in the system or network includes a player identity reader able to identify and distinguish between different players playing the machine.

23. A gaming system or network according to claim 22 wherein the player identity reader is operable to both read data from and write data to a machine readable card associated with the player.

24. A gaming system or network according to claim 23 wherein the player identity reader is operable to provide the award to the other player by writing data indicative of the reward to the machine readable card of the other player.

25. A gaming system or network according to claim 24 comprising a local area network at a single gaming location, a network spanning two or more gaming locations and/or part of a wide area network.

26. A gaming system or network according to claim 13 wherein the award to the other player is awarded by modifying the play characteristics of a game played by the other player on a gaming machine in a player favourable manner.

27. A gaming system or network according to claim 26 wherein the modification comprises any one or more of a modified pay table, modified playing elements so as to result in an increased frequency of winning outcomes, the provision of a feature game, or enhanced eligibility to win a feature game.

28. A gaming system of network according to claim 27 wherein each gaming machine in the system or network includes a player identity reader able to identify and distinguish between different players playing the machine.

29. A gaming system or network according to claim 28 wherein the player identity reader is operable to both read data from and write data to a machine readable card associated with the player.

30. A gaming system or network according to claim 29 wherein the player identity reader is operable to provide the award to the other player by writing data indicative of the reward to the machine readable card of the other player.

31. A gaming system or network according to claim 30 comprising a local area network at a single gaming location, a network spanning two or more gaming locations and/or part of a wide area network.
